(19) United States
(12) Patent Application Publication
(10) Pub. No.: US 2013/0339244 A1
(43) Pub. Date: Dec. 19, 2013

(54) METHODS AND SYSTEMS FOR CHECK CASHING RISK ANALYSIS

(71) Applicant: Certegy Check Services, Inc., Tampa, FL (US)

(72) Inventors: Wenwen WU, Newark, DE (US); Justin HOBART, Kirkland, WA (US); Hao ZHANG, St. Petersburg, FL (US); Jason HOSLER, Lutz, FL (US); Liying ZHANG, Odessa, FL (US); Yachin LIN, Hong Kong (CN); Todd TODARO, Belleair Bluffs, FL (US); Kamila KIBILDA, Riverview, FL (US); Cymbre LOM, St. Petersburg, FL (US); Stuart DWYER, Redmond, WA (US)

(73) Assignee: Certegy Check Services, Inc., Tampa, FL (US)

(21) Appl. No.: 13/916,046

(22) Filed: Jun. 12, 2013

Related U.S. Application Data
(60) Provisional application No. 61/659,160, filed on Jun. 13, 2012.

(51) Int. Cl. G06Q 20/40

(52) U.S. Cl. CPC G06Q 20/40
USPC 705/44

(57) ABSTRACT

Methods, systems, and computer-readable media are disclosed for generating a score for a check cashing transaction. A method includes receiving from a cashing station, having cashing station data, a transaction request including check data and identity data associated with a user, and determining whether the transaction request represents a first transaction request from the user at that cashing station. If so, an enrollment validation process and identification authentication process are performed; if not, a repeat validation process and check casher identification process are performed. The method includes determining whether there is a match between at least one of check data or identity data and data in a negative file or a knowledge file. The method includes calculating a score for the cashing transaction based at least in part on the check data, cashing station data, identity data, or checks of previously received transaction requests, determining whether the score is above a threshold, and approving the transaction based on the determination.

### PRIORITY CLAIM

The present application claims priority to U.S. Provisional Patent Application 61/659,160, filed Jun. 13, 2012, the disclosure of which is hereby incorporated by reference in its entirety.

### TECHNICAL FIELD

The present disclosure generally relates to methods, systems, and computer-readable media implementing scoring models and decision logic for predicting riskiness of check cashing transactions, and making a decision to approve or decline each transaction based on the models and logic.

### BACKGROUND

People who rely upon checks to receive payment or income may “cash” their checks at various locations, such as at a point of sale, a kiosk, or check cashing service. For one reason, such people may be part of a class of “unbanked” people; e.g., those without bank accounts; or the class of “underbanked” individuals, who have limited access to financial services typically offered by financial institutions. Others may prefer the convenience of receiving money from an intermediary rather than waiting for their bank to clear the check after deposit. The process of cashing a check may include the check owner (e.g., a payee) endorsing the back of the check (also known as “signing” the check over to another person or entity) and giving the check to a cashing entity (e.g., a company that allows payees or check owners to cash checks). The check owner then may receive money equal to at least part of the amount printed on the check. (For example, the check owner may receive the amount of the check less a processing fee.) The cashing entity may then deposit the check into its own bank account, allowing the cashing entity to be paid back after the check clears through its bank.

In such transactions, as with many transactions, accepting the check entails a certain amount of risk for the cashing entity. For example, the check may be fraudulent, drawn on a closed account, drawn on an overdrawn account, a duplicate of another check, or the like. If a cashing entity purchases such a check from a check owner and attempts to cash it, the cashing entity may lose its investment in the check because the check is uncollectable. In many types of banking/finance transactions, this risk can be at least partially mitigated by checking the identity of the participants against a database of past activity. For example, in applying for a line of credit or a mortgage, a participant's credit report may be consulted to determine whether the participant is likely to be able to satisfy his obligations under the line of credit.

However, many consumers may not have credit reports. For example, if a consumer does not have a bank account, does not have sufficient credit history, or wishes to remain anonymous, the cashing entity may not have enough information to determine whether the check owner is trustworthy enough to accept a check from him. Even if the consumer is trustworthy, the lack of a credit report or other information about the check owner may cause a cashing entity to avoid purchasing the check from the check owner.

There is also a risk to banks on whose accounts checks are drawn. For example, cashing entities may attempt to cash fraudulent checks, checks drawn on closed or overdrawn accounts, or the like. The banks may become responsible for bad acts by others. Furthermore, cashing entities may implement poor quality control, leading them to accept invalid or bad checks. This may lead to loss for the cashing entities as well as the banks that receive checks from them.

As such, there is a need to provide methods and systems to enable cashing entities to determine a level of risk that a particular check owner and/or check cashing request presents, and to decide whether or not to accept a check based on the risk. There is also a need to provide methods and systems to determine the riskiness of accepting a check cashing transaction based on information related to a cashing entity, a check owner, and a check.

### SUMMARY

The disclosed embodiments include a method for generating a score for a check cashing transaction. The method includes receiving from a cashing station, having cashing station data, a transaction request including check data and identity data associated with a user, and determining whether the transaction request represents a first transaction request from the user at that cashing station. If so, an enrollment validation process and identification authentication process are performed; if not, a repeat validation process and check casher identification process are performed. The method includes determining whether there is a match between at least one of check data or identity data and data in a negative file or a knowledge file. The method includes calculating a score for the cashing transaction based at least in part on the check data, cashing station data, identity data, or checks of previously received transaction requests, determining whether the score is above a threshold, and approving the transaction based on the determination.

The disclosed embodiments also include a system for generating a score for a check cashing transaction. The system comprises a storage device (such as a hard disk or memory) for storing instructions and at least one processor configured to execute those instructions to perform a method. The method includes receiving from a cashing station, having cashing station data, a transaction request including check data and identity data associated with a user, and determining whether the transaction request represents a first transaction request from the user at that cashing station. If so, an enrollment validation process and identification authentication process are performed; if not, a repeat validation process and check casher identification process are performed. The method includes determining whether there is a match between at least one of check data or identity data and data in a negative file or a knowledge file. The method includes calculating a score for the cashing transaction based at least in part on the check data, cashing station data, identity data, or checks of previously received transaction requests, determining whether the score is above a threshold, and approving the transaction based on the determination.

The disclosed embodiments also include a computer-readable storage medium for generating a score for a check cashing transaction. In some embodiments, the computer-readable storage medium may be non-transitory (such as a hard disk, compact disc, or other storage device). The medium includes instructions that, when executed by at least one computer processor, cause the at least one processor to perform a method. The method includes receiving from a cashing station, having cashing station data, a transaction request including check data and identity data associated with a user, and determining whether the transaction request represents a first transaction request from the user at that cashing station. If so, an enrollment validation process and identification authentication process are performed; if not, a repeat validation process and check casher identification process are performed. The method includes determining whether there is a match between at least one of check data or identity data and data in a negative file or a knowledge file. The method includes calculating a score for the cashing transaction based at least in part on the check data, cashing station data, identity data, or checks of previously received transaction requests, determining whether the score is above a threshold, and approving the transaction based on the determination.

The disclosure includes a variety of other features that one of ordinary skill will understand to be useful in implementing variations of the above method, system, and computer-readable medium.

### BRIEF DESCRIPTION OF THE DRAWINGS

FIG. 1 is an exemplary layout of a system for processing check cashing requests, consistent with disclosed embodiments.

FIG. 2A is a flowchart representing an exemplary process for scoring a check cashing request, consistent with disclosed embodiments.

FIG. 2B is a flowchart representing an exemplary process for validating and scoring an enrollment check cashing request, consistent with disclosed embodiments.

FIG. 2C is a flowchart representing an exemplary process for validating and scoring a repeat check cashing request, consistent with disclosed embodiments.

FIG. 3A is a table representing an exemplary check cashing model for use in scoring an enrollment check cashing request, consistent with disclosed embodiments.

FIG. 3B is a table representing an exemplary check cashing model for use in scoring a repeat check cashing request, consistent with disclosed embodiments.

FIG. 4 is an exemplary computing device, consistent with disclosed embodiments.

### DESCRIPTION OF EMBODIMENTS

Reference will now be made in detail to some embodiments, examples of which are illustrated in the accompanying drawings. Wherever possible, the same reference numbers will be used throughout the drawings and disclosure to refer to the same or like parts.

Embodiments of the present disclosure include exemplary methods and systems for determining a level of risk associated with a check cashing request. A cashing station may receive attributes regarding a check and/or a check casher (e.g., a person who owns the check and/or presents it for cashing to a cashing station), and may send those attributes to a decision system. The decision system may use those attributes (among others) to determine a score representing a level of risk associated with accepting and cashing the check. The decision system may then decide, based on the score, whether or not the check should be accepted, and may send a signal corresponding to this decision to the cashing station.

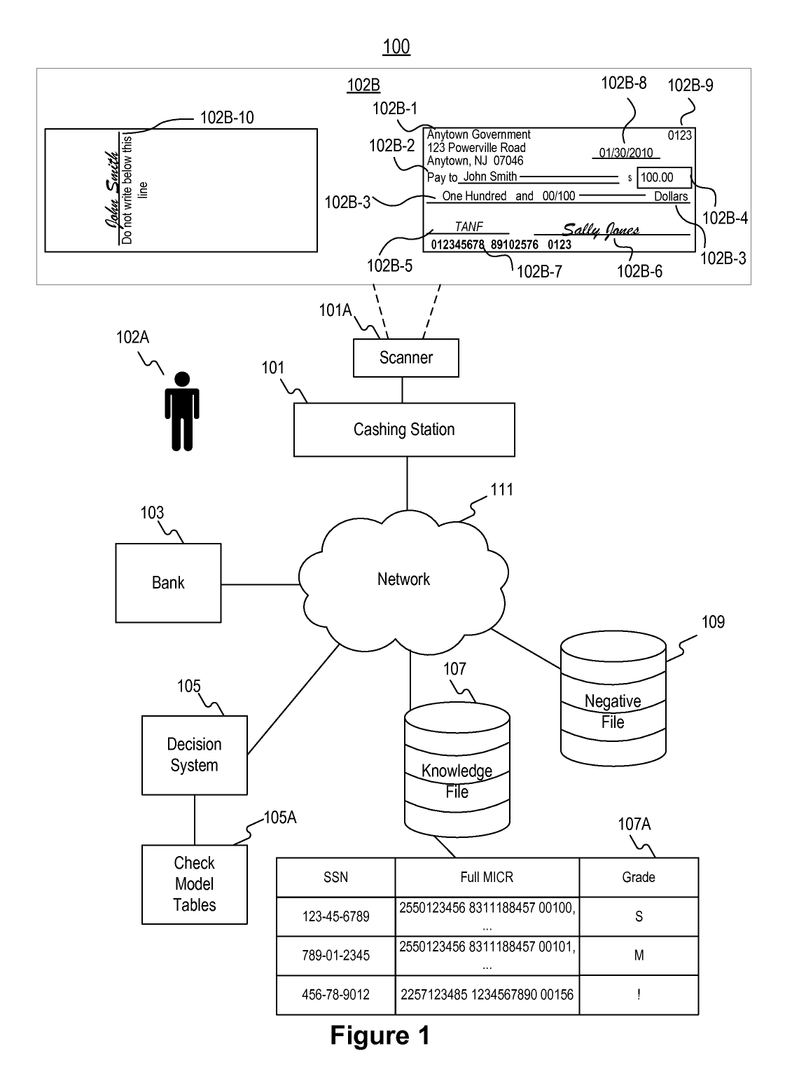

FIG. 1 is an exemplary layout of devices 100, consistent with disclosed embodiments. Layout 100 includes, for example, a cashing station 101, a scanner 101A, a check casher 102A, a check 102B, a bank 103, a decision system 105, check model tables 105A, a knowledge file 107, a negative file 109, and a network 111. As one of ordinary skill will understand, in some embodiments, various ones of the elements in FIG. 1 may be duplicated, substituted, or omitted.

Cashing station 101 may be implemented as a computer or other electronic device operable to accept checks from check casher 102A. In some embodiments, cashing station 101 may be implemented as a point-of-sale (POS) device operable to receive payment information for purchases and check information for deposits. In other embodiments, cashing station 101 may be implemented as an attended machine (e.g., by a cashier or clerk) or an automated kiosk (e.g., by check casher 102A actuating a screen or buttons to deposit the check) operable to receive check information for deposits. In other embodiments, cashing station 101 may be implemented as a personal computer, online terminal, or mobile device operating a software application configured to capture check information, including, among other things, a check image. And, in yet other embodiments, cashing station 101 may be a retail point-of-sale device, e-commerce website, or mobile application configured to receive checking account information that may be used by the decision system to determine whether to approve an “e-check” payment. In such embodiments a physical check may not be present, but rather the user may enter his or her checking account information (or information that may be used to identify such checking account) to effect an electronic check payment for goods or services.

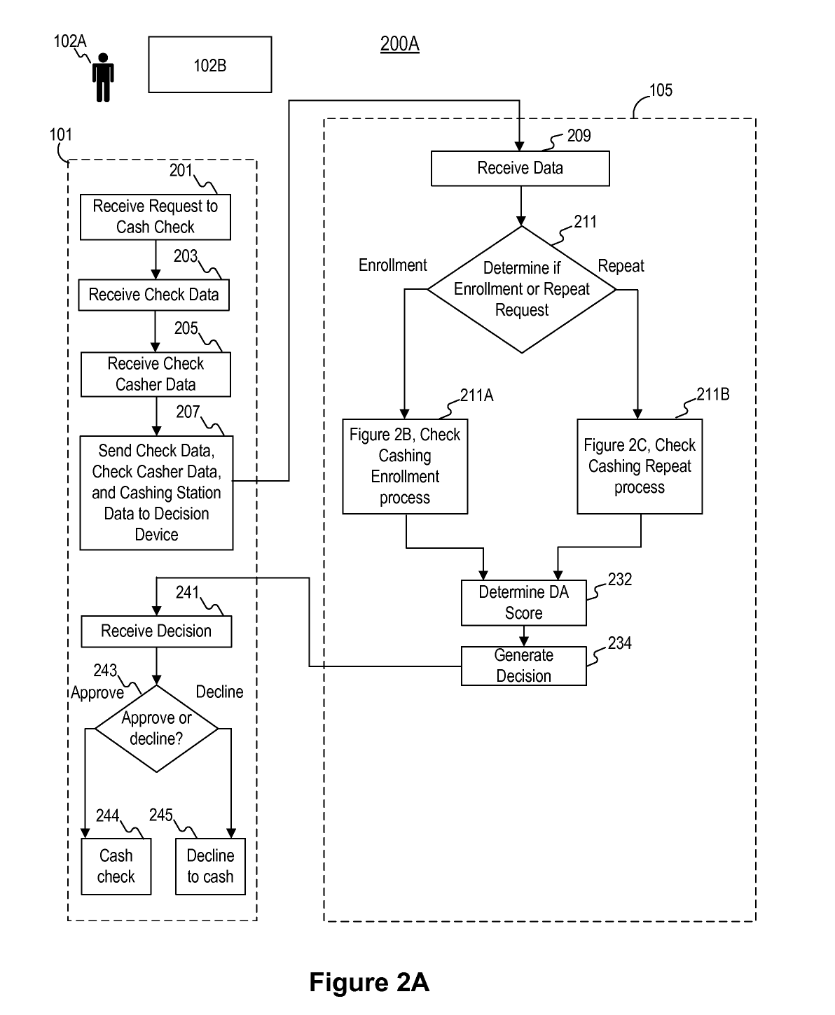

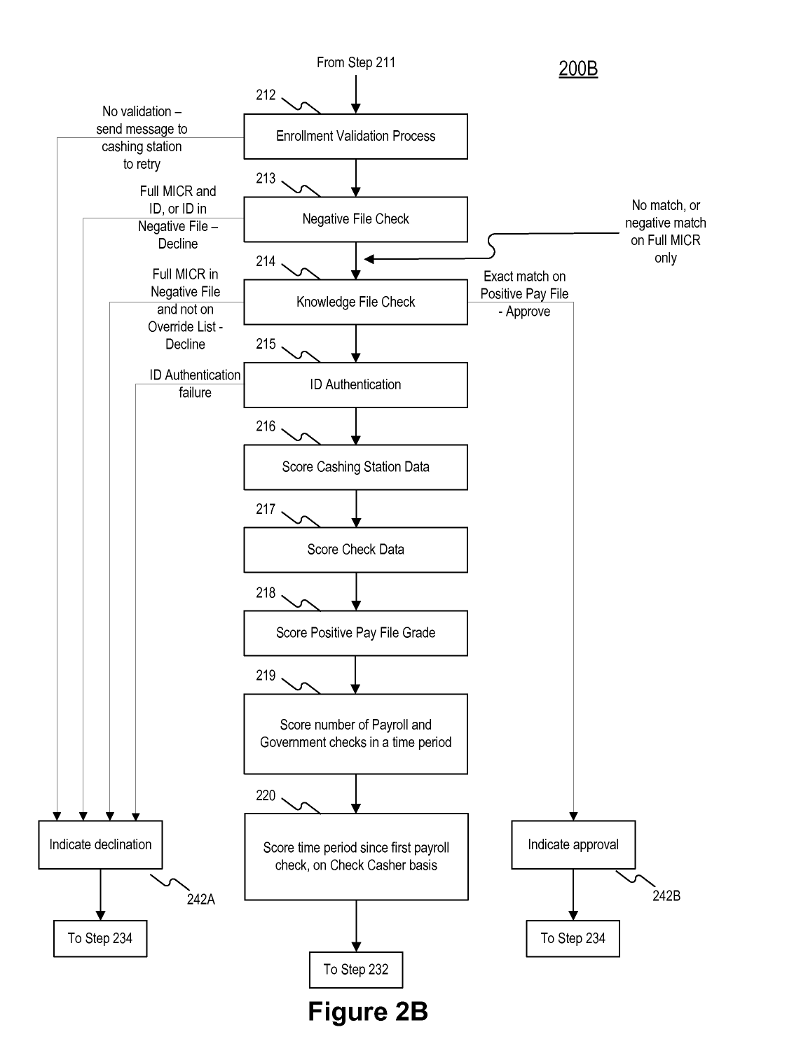

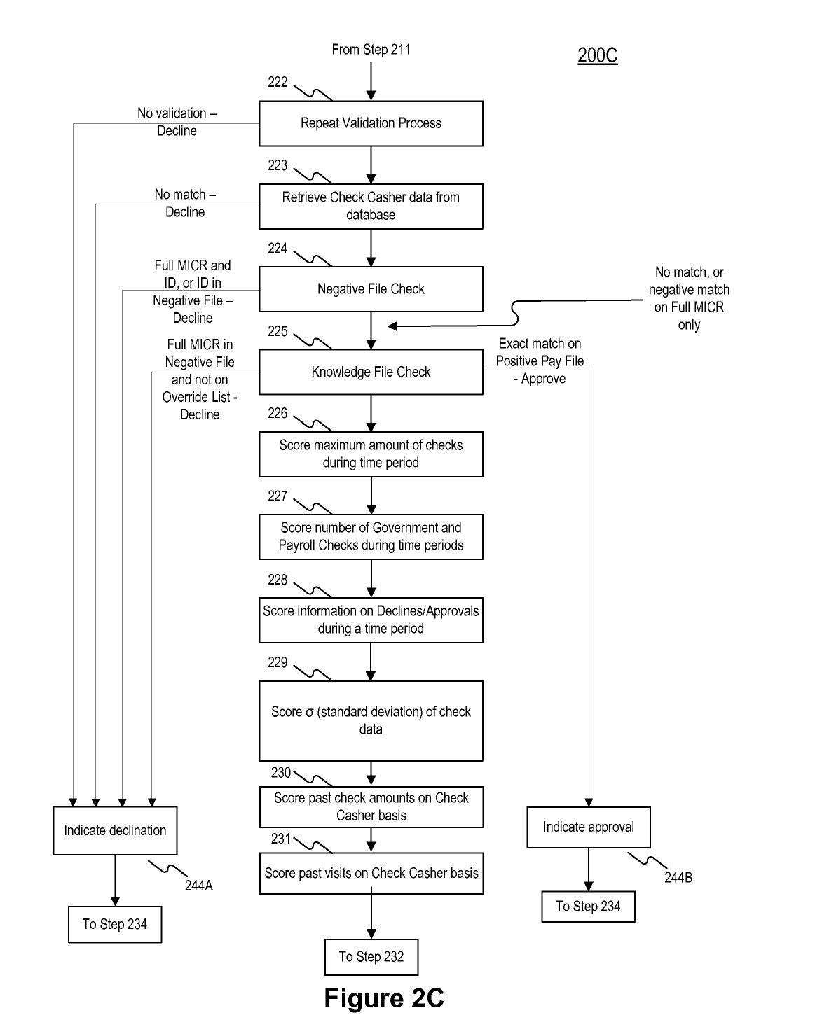

Cashing station 101 may be connected (e.g., via a wired connection, mobile network, or wireless connection) to scanner 101A. Scanner 101A, in some embodiments, may be implemented as an image-based check scanner, a MICR (Magnetic Ink Character Recognition) check scanner, or the like, and may be configured to scan a check (such as check 102B) in order to determine the data printed or written on the front and/or back sides of the check. As used herein, scanner 101A may also represent a camera, such as an embedded mobile camera within a mobile device, which is used to capture an image of a check. Scanner 101A may then send this data to cashing station 101, and cashing station 101 may assemble a check cashing request for sending to other devices, such as decision system 105. (Embodiments of these steps are described below with respect to FIG. 2.)

Check casher 102A represents a person or entity that possesses check 102B. In some embodiments, check casher 102A may be a person whose name appears on the front of check 102B (e.g., on a line listing “Pay To”, meaning that check 102B is owned by check casher 102A). Check casher 102A may also be a person whose name is not on the front of check 102B, but otherwise owns check 102B (e.g., the person whose name is on the front of check 102B has signed check 102B over to check casher 102A to satisfy a debt). Check casher 102A may also be a person who is authorized to sign for and cash checks on behalf of a juridical entity (such as a corporation, association, or organization).

Check 102B is an exemplary financial instrument such as typical paper checks used in the United States. For example, check 102B may be any of a payroll check, a government check (e.g., welfare), an insurance check, a financial dividend check, a cashier's check, a money order, a two-party personal check (e.g. a check endorsed by two parties for deposit by one of them), a government-issued tax refund check, a privately-issued tax refund check, a RAL (Refund Anticipation Loan) check, a rebate check, or the like.

The front of check 102B may include, for example, written or printed text identifying a payor 102B-1, a payee 102B-2, an amount (or “legal amount”) 102B-3, a numerical amount (or “courtesy amount”) 102B-4, a memo line 102B-5, a signature 102B-6, a MICR line 102B-7, a date 102B-8, and a check number 102B-9. The back of check 102B may include an endorsement line 102B-10.

In some embodiments, payor 102B-1 represents the entity (e.g., an individual, a couple, a corporation, an organization, or the like) that issued the check. The entity represented by payor 102B-1 may also represent the entity from whose account the amount of the check will be deducted if the check is cashed.

In some embodiments, payee 102B-2 represents the entity (e.g., check casher 102A) that the check is issued to. Payee 102B-2 may also be known, colloquially, as the entity that the check is “made out to.” Payee 102B-2, in some embodiments, may be an entity that is designated to cash the check (e.g., a person accepting payment for services he has performed), may be an intermediary that is designated to accept the check on behalf of another individual (e.g., a guardian), or may be an entity that is designated to receive the check but ultimately signs the check over to another individual for cashing (e.g., a person authorized to accept checks on behalf of an organization).

Amount 102B-3 and numerical amount 102B-4, in some embodiments, represent the amount of money that the check is worth. Amount 102B-3, in some embodiments, may be written out in alphanumeric text. So, for example, if payor 102B-1 owes payee 102B-2 one hundred United States dollars ($100.00 USD), payor 102B-1 can issue a check that states “One Hundred and 00/100 dollars” in amount 102B-3, and can list “$100.00” in numerical amount 102B-4. According to American Bankers Association (ABA) rules, in case of a discrepancy between amount 102B-3 and numerical amount 102B-4, amount 102B-3 would control. One of ordinary skill in the art would recognize that other rules are possible as well.

Memo line 102B-5 is, in some embodiments, an optional note made by payor 102B-1. In some embodiments, memo line 102B-5 represents the purpose of the check. Signature 102B-6, in some embodiments, represents a binding agreement that payor 102B-1 will pay payee 102B-2 the amount listed in amount 102B-3.

MICR line 102B-7, in some embodiments, is a line of data about the account of payor 102B-1. For example, MICR line 102B-7 may include a routing number (representing, e.g., the financial institution which holds the account), an account number (e.g., a unique numerical identifier representing the account of payor 102B-1), and a check number (e.g., a unique numerical identifier representing the number of check 102B-9). The term MICR stands for Magnetic Ink Character Recognition. Thus, in some embodiments, MICR line 102B-7 may be printed using a magnetic ink, for example, ink containing iron oxide or another magnetic element. Point-of-sale devices may use magnetic check reading devices (not pictured) to determine data on the account of payor 102B-1 or check 102B, even if the other text on check 102B is illegible.

Date 102B-8 may indicate the date that the check was signed or delivered to payee 102B-3. Check number 102B-9 may indicate a unique identifier for a particular set of checks owned by payor 102B-1. This enables, for example, payor 102B-1 to cancel or stop a particular check from being cashed, by informing his bank that a check corresponding to a particular check number should be prevented from being cashed.

The back of check 102B may include, for example, endorsement line 102B-10. Endorsement line 102B-10 enables payee 102B-1 (or another person) to sign check 102B for deposit, to transfer check 102B to another (for example, to satisfy another debt owed by payee 102B-2 to another person), or the like.

Bank 103 represents a financial institution on which checks, such as check 102B, are drawn (e.g., the bank that holds the account represented by the check). Bank 103 may also represent a financial institution holding accounts, accounts that check casher 102A indicates to cashing station 101 as security for cashing checks (e.g., to provide cashing station 101 with a high level of trust that the check will not bounce).

Decision system 105 represents a system that is operable to receive information about a check deposit request (such as data about check casher 102A, data about or printed on check 102B, data about cashing station 101, or the like), consult databases (such as knowledge file 107 or negative file 109) and check acceptance models (such as those stored in check model tables 105A) to determine points corresponding to values associated with the check deposit request, and generate a determination of the riskiness of cashing that check. In some embodiments, the determination of riskiness may be a score that indicates the likelihood that a transaction is fraudulent.

In some embodiments, the score may be generated on an exponential scale. For example, the scale may be configured such that each 50-point increase in the score indicates that the probability of a check with a score being fraudulent is half as likely as a check with a score of 50 fewer points. For example, 400 points may indicate 30-to-1 odds that the check cashing transaction will result in a loss to the check cashing entity (e.g., because the check is fraudulent, is drawn on a closed or overdrawn account). Thus, a score of 450 decreases the odds of a fraudulent transaction to 60-to-1, while a score of 300 increases the odds to 7.5-to-1. These particular values are not required in all embodiments. One of ordinary skill will understand that other bases, scales, and odds are possible in some embodiments.

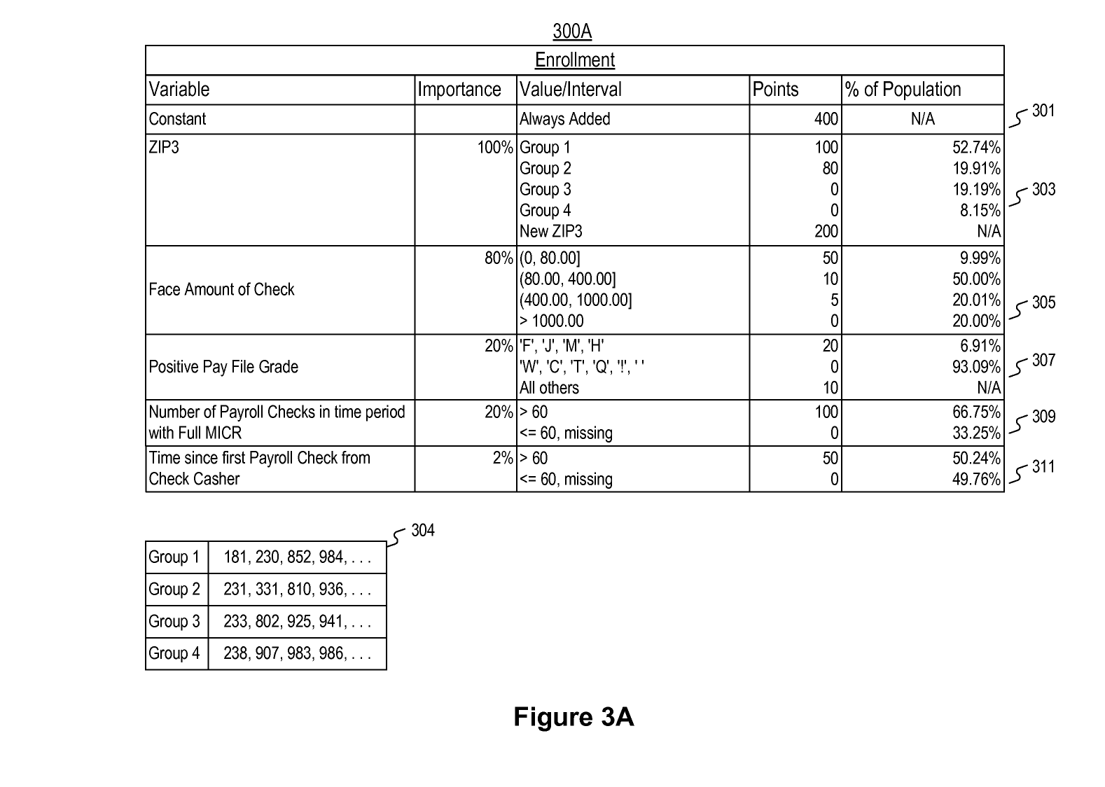

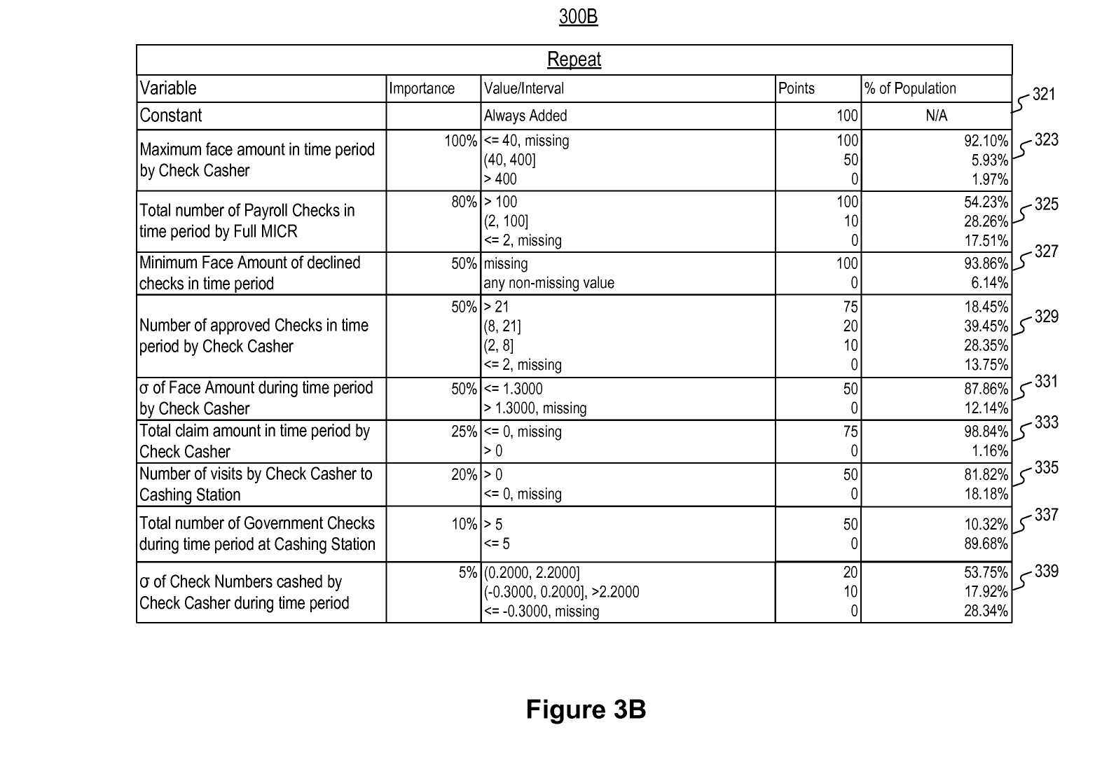

Check model tables 105A may be implemented as a database, a data store, or the like. Check model tables 105A may contain multiple tables containing representations of check cashing decision models. Each table may be usable to score a particular type of check cashing transaction based on information associated with the transaction, the check casher, or the cashing station. For example, check model tables 105A may contain a first table usable to generate a score for an “enrollment” transaction (e.g., the first time that a particular person has attempted to cash a check at a particular cashing station) and a second table usable to generate a score for a “repeat” transaction (e.g., when a person who has previously cashed checks at a particular cashing station attempts to cash another check). These tables are explained below with respect to FIGS. 3A and 3B, but one of ordinary skill will understand that other tables are possible as well. Check model tables 105A may be implemented as a separate device, or implemented as part of, decision system 105 (e.g., on a storage device that inside of decision system 105, such as an internal hard drive).

Knowledge file 107 may be implemented as a database, data store, or electronic device configured to store information on full MICR lines (e.g., a magnetic line of characters printed across the bottom of check 102B). In some embodiments, the full MICR lines in knowledge file 107 correspond to checks that should be accepted because they have been pre-approved or are otherwise known to be valid. Knowledge file 107 may also include a database containing override MICR lines, which are printed on checks that should not be declined merely because the checks are referenced in negative file 109. Knowledge file 107 may also contain identification information of check casher 102A (for example, a social security number associated with check casher 102A).

In some embodiments, knowledge file 107 may contain a table 107A that links three pieces of information: identification information of check casher 102A, individual full MICR lines, and a grade corresponding to check casher 102A. (For example, each element or line of the table may contain a social security number corresponding to a check casher, multiple full MICR lines corresponding to valid checks, and the grade.) The grade corresponding to check casher 102A may be based on, for example, how many checks check casher 102A has deposited successfully (i.e., without receiving a declination). So, for example, check casher 102A may have a high grade if check casher 102A has deposited 100 checks without a declination, and may have a low grade if check casher 102A has deposited only five checks with the last three being declined (e.g., for insufficient funds).

Negative file 109 may be implemented as a database, data store, or electronic device configured to store information on full MICR lines and/or identification documents (such as driver licenses) that, if presented, should cause the check cashing transaction to be declined. In some embodiments, the full MICR lines in negative file 109 correspond to checks that should be declined because they have been flagged beforehand. For example, checks corresponding to MICR lines in negative file 109 may be checks that are known to be fraudulent, drawn on closed or overdrawn accounts, or the like. Similarly, identification documents referenced in negative file 109 may correspond to known fake documents (such as falsified or duplicate driver licenses).

Network 111 may be a network that is configured to provide communication between components of layout 100 depicted in FIG. 1. Network 111 may be implemented, in some embodiments, as one or more networks that connect devices in network layout 100 to allow communication between them. For example, as one of ordinary skill in the art will recognize, network 111 may be implemented as the Internet, a wireless network, a wired network, a local area network (LAN), or any other type of network that provides communications between one or more components of network layout 100.

FIG. 2A is a flowchart representing an exemplary process 200A for scoring a check cashing request. This process includes steps of receiving and sending data between cashing station 101 and decision system 105; however, in some embodiments, other devices or entities (such as knowledge file 107 or negative file 109) may also be utilized in performing the process represented in flowchart 200A.

The process in FIG. 2A may begin at step 201, where cashing station 101 receives a request to cash a check. In some embodiments, such as those embodiments where cashing station 101 is implemented as an attended kiosk, such as a point-of-sale device, step 201 may represent a step of a clerk/cashier receiving a check from a check casher 102A in person. A clerk or cashier at cashing station 101 may then actuate an input device at cashing station 101 to initiate a check cashing process. In other embodiments, such as where cashing station 101 is implemented as a stand-alone device actuated by check casher 102A, step 201 may represent a step of check casher 102A actuating cashing station 101 to initiate a check cashing process. In yet other embodiments in which the cashing station 101 is a mobile device, step 201 may involve a user initiating the check cashing process by, e.g., actuating a button on a user interface, using a voice command, or performing a gesture.

In step 203, cashing station 101 may receive data concerning the check. This data may include attributes indicating, for example, the payor (e.g., the issuer of the check), the payee (e.g., check casher 102A or the person on the “Pay To” line of the check, as appropriate), the address of the payor, the date printed or written on the check, the check number, the amount printed or written on the check (e.g., at least one of the courtesy amount or the actual amount), the memo printed or written on the check, the signature on the check, the MICR line, or the like.

This data may be received from a device connected to cashing station 101. For example, as explained above with respect to FIG. 1, a clerk or cashier at cashing station 101 may receive the check in person from check casher 102A and use scanner 101A to extract data from check 102B. In some embodiments, scanner 101A may be implemented as an image-based scanner and/or a camera. In these embodiments, scanner 101A may utilize technology such as Optical Character Recognition to determine the data printed or written on check 102B. In other embodiments, scanner 101A may be implemented as a MICR scanner configured to read a magnetic line of data (the “MICR line”) printed on the bottom of check 102B.

Step 203 may also include a process of manually entering the check data. There can be problems when checks are automatically scanned to extract the data printed or written on them. For example, if the MICR line on check 102B has been corrupted, partially removed or demagnetized, if the data on check 102B is unreadable, illegible, in another language, or the like, then a check may not be automatically readable using a device such as scanner 101A. Thus, step 203 also may represent a process whereby a clerk, cashier, or check casher 102A manually entering attributes printed on the check. For example, a clerk, cashier, or check casher 102A may type the data from check 102B into cashing station 101 using a keyboard.

In step 205, cashing station 101 may also receive data concerning check casher 102A. For example, a cashier at cashing station 101 may use scanner 101A to scan a driver's license or other document, or may receive a bank account number from check casher 102A (e.g., to secure the check cashing request), a social security number or other unique identifier for check casher 102A, a date of birth for check casher 102A, or the like.

In step 207, cashing station 101 may construct and send a check cashing request to decision system 105. The request may include, for example, data concerning cashing station 101 (such as an identifier for cashing station 101, information about the geographic location of cashing station 101, or the like), data concerning check casher 102A, data concerning check 102B, or the like. Cashing station 101 may send the request over a network (such as network 111 in FIG. 1).

In step 209, decision system 105 may receive the check cashing request constructed and sent by cashing station 101 in step 207. Decision system 105 then may determine, in step 211, whether the check cashing request indicates an “enrollment request” or a “repeat request.” In some embodiments, decision system 105 may determine whether the check cashing request received in step 209 represents a first time that check casher 102A has attempted to cash a check by consulting knowledge file 107. Decision system 105 determining whether this is the first check cashing request from check casher 102A comprises, for example, determining whether there are any past transactions from check casher 102A in knowledge file 107.

If, for example, the request in step 209 is the first request from check casher 102A at cashing station 101, then decision system 105 may interpret a check cashing request as an “enrollment” request. If so, decision system 105 may execute a cashing enrollment sub-process to determine risk associated with accepting check 102B from check casher 102A, represented by step 211A and explained below with respect to FIG. 2B.

If, on the other hand, this is not the first time that check casher 102A has attempted to cash a check at cashing station 101, then decision system 105 may interpret the check cashing request as a “repeat” request. Decision system 105 may execute a cashing repeat sub-process to determine risk associated with accepting check 102B from check casher 102A, represented by step 211B and explained below with respect to FIG. 2C.

After calculating a score using one of the cashing enrollment process in step 211A or the cashing repeat process in step 211B, decision system 105 may combine the determined scores, in step 232, to determine a risk score (“Decision Attributes Score” or “DA Score”) for the check cashing request.

In step 234, decision system 105 may determine, based on the score, whether to approve the transaction. Decision system 105 may determine score thresholds for acceptance or declination based on a history of received checks. For example, if decision system 105 determines that a high percentage of checks having a DA score of less than 200 were returned or otherwise not able to be processed, decision system 105 may set a “low” threshold of 200, such that any checks with a DA score lower than 200 will be declined. Similarly, decision system 105 may also set high score thresholds for approving checks.

Decision system 105 may then, in some embodiments, send an indication to cashing station 101 that the cashing request should be declined. In some embodiments, decision system 105 may also send a reason code to cashing station 101 with the indication.

In step 241, cashing station 101 may receive the decision sent by decision system 105 in step 234. Cashing station 101 may then, in step 243, determine whether the decision indicates that the cashing request should be approved or declined. If cashing station 101 determines that the cashing request should be approved, cashing station 101 may execute a process represented in step 244 to cash the check. This process includes, for example, giving money to check casher 102A, indicating check 102B as processed by signing or printing on its reverse, processing check 102B through the ACH system, or sending check 102B or related data to bank 103 (e.g., sending check 102B to a bank holding an account associated with decision system 105 for deposit or to a bank associated with the account on which check 102B is drawn).

If, however, cashing station 101 determines that the cashing request should be declined, cashing station 101 may execute a process represented in step 245 to decline the check cashing request. This process includes, for example, informing check casher 102A that the check cannot be cashed and, in some embodiments, advising check casher 102A as to whether a request to cash check 102B may be attempted again.

FIG. 2B is a flowchart representing an exemplary process 200B for validating and scoring an enrollment check cashing request. As explained above with respect to FIG. 2A, process 200B in FIG. 2B represents a sub-process executed when decision system 105 determines that the check cashing request received in step 209 of FIG. 2A is the first check cashing request received from check casher 102A at cashing station 101.

Beginning in step 212, decision system 105 may execute an enrollment validation process. This may include, for example, determining an identifier (e.g., a number) associated with cashing station 101, validating an ABA number (“American Bankers Association” number; also known as a Routing Number) and/or account number associated with check 102B, performing a process of early warning validation (for example, sending a request to bank 103 to determine if an account associated with check 102B is open or closed), validating information related to a driver's license or other identification presented by check casher 102A, validating a date of birth or social security number associated with check casher 102A, or the like. Decision system 105 may perform the enrollment validation process in step 212 by consulting outside databases (such as credit reports, databases of consumer information) to find matches with information provided by check casher 102A.

If decision system 105 determines that the enrollment validation process in step 212 has failed for one or more reasons (e.g., the social security number and name provided by check casher 102A do not match one another), decision system 105 may proceed to step 242A where the transaction may be declined and an indication of this declination may be provided to cashing station 101 (as represented in step 234 of FIG. 2A). In some embodiments, if decision system 105 determines that the enrollment validation process in step 212 has failed, decision system 105 may determine that check casher 102A should be able to try the check cashing request again (e.g., because a date of birth or social security number was possibly miskeyed by a clerk or user at cashing station 101), and may indicate so in its message to cashing station 101.

If decision system 105 determines that the enrollment validation process in step 212 passes, decision system 105 may proceed to step 213 to perform a negative file check process. In step 213, decision system 105 may consult negative file 109 (in FIG. 1) to determine whether the full MICR of check 102B or the identification offered by check casher 102A (e.g., a driver's license) appear in negative file 109. In some embodiments, if decision system 105 determines that both the full MICR and the identification are referenced in negative file 109, decision system 105 may proceed to step 242A where the transaction may be declined and an indication of this declination may be provided to cashing station 101 (as represented in step 234 of FIG. 2A). In further embodiments, decision system 105 may also decline the transaction (as in step 242A) if only the identification is referenced in negative file 109.

If decision system 105 determines that the identification data does not appear in negative file 109, or that only the full MICR appears in negative file 109, decision system 105 may proceed to step 214 to perform a knowledge file check process. In step 214, decision system 105 may consult knowledge file 107 to determine whether, for example, the check cashing request is in knowledge file 107 (e.g., as a pre-approved check cashing transaction), a full MICR of check 102B is on an override list (indicating, for example, that check 102B should be approved even though it may have been present in negative file 109), or the like.

In some embodiments, the process in step 214 may include determining whether a full MICR associated with check 102B found in negative file 109 is also on an override list in knowledge file 107. For example, if decision system 105 determines that the full MICR is present in negative file 109, but determines that the full MICR is also on an override list in knowledge file 107, decision system 105 may proceed to step 242B, where decision system 105 may generate an indication of approval for sending to cashing station 101.

If the knowledge file check in step 214 passes, decision system 105 may perform a process of identification (ID) authentication in step 215. This includes, for example, checking identification data provided by check casher 102A against known databases (such as libraries of consumer information or the like). If the ID authentication process in step 215 fails, decision system 105 may proceed to step 242A, where an indication of declination is generated for sending to cashing station 101. If, on the other hand, the ID authentication process in step 215 passes, decision system 105 may proceed to step 216 to begin scoring the transaction for risk.

Steps 216-220 represent process steps for generating a score related to (or “scoring”) attributes in the check cashing request received in step 209 of FIG. 2A. In some embodiments, scoring attributes related to the check cashing request may be accomplished by consulting tables listing correlations between possible values associated with a check cashing transaction and points related to riskiness of the transaction (such as check model tables 105A in FIG. 1). In some embodiments, the possible values may be organized into ranges or groups. For example, if one of the values is related to the amount of the check, one point value may be assigned to checks with amounts above $100.00, while another point value may be assigned to checks with amounts equal to or less than $100.00. Decision system 105 may then combine these values to generate a risk score related to the check cashing transaction.

In some embodiments, decision system 105 may utilize a different model depending on the particular type of check presented by check casher 102A. For example, if decision system 105 determines that a check cashing request refers to a government check (e.g., a welfare check), decision system 105 may consult a table that contains values and points tailored for the process of cashing a government check. If decision system 105 determines, however, that the check cashing request refers to a payroll check, decision system 105 may consult a different table, the values and points of which are tailored for the process of cashing a payroll check. (Example values and points are explained below with respect to FIGS. 3A and 3B.)

In step 216, decision system 105 may determine a score for data related to cashing station 101. For example, as a basis for determining a score, decision system 105 may determine a ZIP code associated with cashing station 101, by receiving the ZIP code as part of the check cashing request (in step 209 of FIG. 2A), or by looking up the ZIP code associated with cashing station 101 in knowledge file 107. Decision system 105 may then determine a subset of the ZIP code (such as the first three digits of the ZIP code), and look up that ZIP code subset in check model tables 105A to determine points associated with that ZIP code subset.

In some embodiments, check model tables 105A may contain groups of ZIP code subsets, such that each set of ZIP code subsets is associated with different points. So, when decision system 105 looks up a ZIP code subset in check model tables 105A, decision system 105 may determine points associated with the ZIP code subset by determining the group that the ZIP code subset is in.

In step 217, decision system 105 may determine a score for data related to check 102B. For example, decision system 105 may determine the “face amount” of the check (e.g., the amount printed on the check or that the check is worth). Decision system 105 may then look up the face amount in check model tables 105A to determine points associated with the face amount.

In step 218, decision system 105 may determine a score for data related to a Positive Pay File (PPF) grade. As explained above with respect to FIG. 1, table 107A may contain a grade corresponding to at least one of check casher 102A or check 1028. The grade may indicate a level of confidence that check casher 102A has attempted to cash a check that is going to clear when cashed by cashing station 101. In some embodiments, check casher 102A may be assigned one of five grades. Each grade may indicate a different level of confidence that check casher 102A is a trustworthy individual. In some embodiments, each grade may indicate a level of trustworthiness that allows check casher 102A to override a particular dollar limit for check cashing requests. So, for example, one grade may enable check casher 102A to override a cashing limit of $1000.00 per month, while another grade may enable check casher 102A to override a cashing limit of $1500.00 per month.

In step 219, decision system 105 may determine a score for data related to the number of payroll checks cashed at a particular cashing station during a period of time. For example, decision system 105 may determine the number of payroll checks cashed at a particular cashing station during the previous 30 days by consulting a database such as knowledge file 107. Decision system 105 may then look up the determined number of payroll checks in check model tables 105A to determine points associated with that number. For example, one point value is assigned to a value of “35 checks or greater,” and another point value is assigned to “less than or equal to 35 checks.”

Step 219 may also, in some embodiments, represent decision system 105 determining a score for data related to approved government checks. For example, in situations where check 102B represents a government check, decision system 105 may determine a score related to a total number of approved government checks having the same full MICR line during the past 3 months, by consulting a database such as knowledge file 107. Decision system 105 may then look up the determined number of approved government checks in check model tables 105A to determine points associated with the number of approved checks. For example, one point value is assigned to a value of “5 checks or greater,” and another point value is assigned to “less than or equal to 5 checks.”

In step 220, decision system 105 may determine a score for data related to the amount of time since check casher 102A first presented a payroll check. For example, decision system 105 may determine the number of days since check casher 102A first presented a payroll check for deposit by consulting a database such as knowledge file 107. Decision system 105 may then look up the determined number of days since first deposit in check model tables 105A to determine points associated with the number of days. For example, one point value is assigned to a value of “40 checks or greater,” and another point value is assigned to “less than or equal to 40 checks.”

After determining the scores in steps 216-220, decision system 105 may then return to step 232 in FIG. 2A for calculating the Decision Attributes score.

FIG. 2C is a flowchart representing an exemplary process 200C for validating and scoring a repeat check cashing request. As explained above with respect to FIG. 2A, FIG. 2C represents a sub-process executed when decision system 105 determines that the check cashing request received in step 209 of FIG. 2A is not the first check cashing request received from check casher 102A at cashing station 101.

Beginning in step 222, decision system 105 may execute a repeat validation process. This may include, for example, validating an ABA number (“American Bankers Association” number; also known as a Routing Number) and/or account number associated with check casher 102A, performing a process of early warning validation (as explained above with respect to FIG. 3A), or the like. Decision system 105 may perform the enrollment validation process in step 212 by consulting outside databases (such as credit reports, consumer information databases, or the like).

If decision system 105 determines that the enrollment validation process in step 222 has failed for one or more reasons (e.g., the ABA number provided by check casher 102A is invalid), decision system 105 may proceed to step 242A where the transaction may be declined and an indication of this declination may be provided to cashing station 101 (as represented in step 234 of FIG. 2A).

If decision system 105 determines that the enrollment validation process in step 222 passed, decision system 105 may proceed to step 223 to perform a process of retrieving data on check casher 102A from a database (such as knowledge file 107). Because the process in FIG. 2C represents a repeat transaction (i.e., that this is not the first time that check casher 102A has attempted to cash a check), decision system 105 may consult a database to retrieve information for validating the identity of check casher 102A. For example, decision system 105 may retrieve the identity of check casher 102A (such as a social security number), information about identification documents associated with check casher 102A (such as drivers licenses), the most recent date on which check casher 102A attempted to cash a check, or the like. This data may be compared to data received from cashing station 101. If there is no match, decision system 105 may proceed to step 244A to indicate that the check cashing request should be declined.

If however, decision system 105 determines that there is a match between data received from cashing station 101 and data retrieved in step 223, decision system 105 may proceed to step 224 to perform a negative file check process. In step 224, decision system 105 may consult negative file 109 (in FIG. 1) to determine whether the full MICR of check 102B or the identification offered by check casher 102A (e.g., a driver's license) appear in negative file 109. In some embodiments, if decision system 105 determines that both the full MICR and the identification are referenced in negative file 109, decision system 105 may proceed to step 244A, to decline the transaction and provide an indication that the transaction has been declined to cashing station 101 (as represented in step 234 of FIG. 2A). In further embodiments, decision system 105 may also decline the transaction (as in step 244A) if only the identification is referenced in negative file 109.

If decision system 105 determines that the identification information does not appear in negative file 109, or that only the full MICR appears in negative file 109, decision system 105 may proceed to step 225 to perform a knowledge file check process. In step 225, decision system 105 may consult knowledge file 107 and/or knowledge file 107 to determine whether, for example, the check cashing request is in knowledge file 107 (e.g., as a pre-approved check cashing transaction), a full MICR of check 102B is on an override list (indicating, for example, that check 102B should be approved even though it may have been present in negative file 109), or the like.

In some embodiments, the process in step 225 may include determining whether a full MICR associated with check 102B found in negative file 109 is also on an override list in knowledge file 107. For example, if decision system 105 determines that the full MICR is present in negative file 109, but determines that the full MICR is also on an override list in knowledge file 107, decision system 105 may proceed to step 244B, where decision system 105 may generate an indication of approval for sending to cashing station 101.

If the knowledge file check in step 225 passes, decision system 105 may proceed to step 226 to begin scoring the transaction for risk. As explained above with reference to FIG. 2B, steps 226-231 represent process steps for generating a score related to (or “scoring”) attributes in the check cashing request received in step 209 of FIG. 2A. In some embodiments, scoring attributes from the check cashing request may be accomplished by consulting tables listing correlations between possible values associated with a check cashing transaction and points related to riskiness of the transaction (such as check model tables 105A in FIG. 1). In some embodiments, the possible values may be organized into ranges or groups. For example, if one of the values is related to the amount of the check, one point value may be assigned to checks with amounts above $100.00, while another point value may be assigned to checks with amounts equal to or less than $100.00. Decision system 105 may then combine these values to generate a risk score related to the check cashing transaction. (Example values and points are explained below with respect to FIGS. 3A and 3B.)

In step 226, decision system 105 may determine a score for data related to a maximum face amount of checks cashed by check casher 102A during a period of time. For example, decision system 105 may consult knowledge file 107 to determine the maximum face amount of all checks cashed by check casher 102A over the past three days (e.g., the past 72 hours, the past three business days, or the like). One of ordinary skill will understand that other values are possible (e.g., all checks cashed by check casher 102A over the past five days, the last 20 checks cashed by check casher 102A, or the like).

In step 227, decision system 105 may determine scores for data related to the number of payroll and government checks received during periods of time. For example, decision system 105 may consult knowledge file 107 to determine the number of payroll checks received in the past 30 days, based on the full MICR associated with each check. This indicates, for example, the number of payroll checks that are coming from the same source (e.g., the same bank account). Decision system may also, for example, consult knowledge file 107 to determine the number of government checks received from a particular cashing station (such as cashing station 101) during the past 12 months.

In step 228, decision system 105 may determine scores for information on declined and approved check cashing requests during particular time periods. For example, decision system 105 may consult knowledge file 107 to determine the minimum face amount of declined checks during the past three days for check casher 102A, to determine the number of approved checks during the past six months for check casher 102A, or the like. One of ordinary skill will understand that variations on these values are possible (e.g., the number of approved checks during the past two weeks, the number of declined check cashing requests during the past two months, etc.).

Step 228 may also, in some embodiments, represent decision system 105 determining a score for data related to approved government checks. For example, in situations where check 102B represents a government check, decision system 105 may determine a score related to a total number of approved government checks having the same full MICR line during the past 3 months, by consulting a database such as knowledge file 107. Decision system 105 may then look up the determined number of approved government checks in check model tables 105A to determine points associated with the number of approved checks. For example, one point value is assigned to a value of “10 checks or greater,” and another point value is assigned to “less than or equal to 10 checks.”

In step 229, decision system 105 may determine scores for statistics of data associated with checks. For example, decision system 105 may consult knowledge file 107 to determine the standard deviation for face amounts of checks cashed by check casher 102A during the past 24 months, may determine the standard deviation between check numbers associated with checks cashed by check casher 102A during the past 6 months, or the like. One of ordinary skill will understand that variations on these values are possible (e.g., the standard deviation of face amounts of cashed checks in the past two weeks, the standard deviation of check numbers for cashed checks in the past two months, etc.).

In step 230, decision system 105 may determine a score for past face amounts for check cashing requests submitted by check casher 102A. For example, decision system 105 may consult knowledge file 107 to determine the total claim amount during a time period spanning three months prior to 24 months prior or the like. One of ordinary skill will understand that variations on these values are possible (e.g., the total claim amount during the six months, the total claim amount during a two-week period measured from six months before today, etc.).

In step 231, decision system 105 may determine a score for past visits by check casher 102A. For example, decision system 105 may consult knowledge file 107 to determine whether check casher 102A has visited cashing station 101 during the previous 24 months. One of ordinary skill will understand that variations on these values are possible (e.g., whether check casher 102A has visited cashing station 101 during the previous 12 months, two months, or the like).

After determining the scores in steps 226-231, decision system 105 may then return to step 232 in FIG. 2A for calculating the Decision Attributes score.

FIG. 3A is a table 300A representing an exemplary check cashing model for use in scoring an enrollment check cashing request, consistent with disclosed embodiments. Table 300A includes variables of varying importance, and correlates values (or ranges of values) for those variables with points. Decision system 105 may use table 300A to score check cashing requests. In some embodiments, decision system 105 may consult databases, such as knowledge file 107, to determine information about check casher 102A, check 102B, bank 103, or cashing station 101.

In some embodiments, the points awarded to a check cashing request having a variable with a particular value are based on the percentage of observed checks (e.g., previously deposited or cashed checks) having the particular value (“% of Population” in FIG. 3A) and the degree to which the particular value is predictive of loss (“Importance” in FIG. 3A).

As an example, a variable with a high value of importance may have two possible values, “A” (a low risk value) and “B” (a high risk value). The low risk “A” value may also be associated with a high percentage of the population, while the high risk “B”value may be associated with a low percentage of the population (and checks having the “B” value may be associated with a high rate of financial loss). Check cashing requests having the low risk “A” value may receive a large number of points, while check cashing requests having the high risk “B” value may receive a relatively smaller number of points (or zero points).

As another example, a variable with a low value of importance may have two other possible values, “Y” (a low risk value) and “Z” (a high risk value). The low risk “Y” value and the high risk “Z” value may both be associated with roughly half of the population, and the loss rate associated with both values may be roughly the same. Thus, check cashing requests having the low risk “Y” value may receive only slightly more points than check cashing requests having the high risk “Z” value.

One of ordinary skill will understand that the particular variables and values are provided for example only, and may be substituted, omitted, or modified as appropriate. In some embodiments, and as described above with respect to FIGS. 2A-2C, decision system 105 may use the score model represented by table 300A to score check cashing requests.

Table 300A may include a constant point value field 301. Decision system 105 may add a constant point value from field 301 when calculating a risk score for a check cashing request. The constant point value may be calibrated such that scores generated using table 300A are correlated to risk. For example, the score may be generated on an exponential scale as explained above with respect to FIG. 1.

Table 300A may further include ZIP3 field 303, which indicates a portion of a Zone Improvement Plan code (commonly known as a “ZIP code”) associated with cashing station 101. As certain areas of the country may be more prone to check fraud, a ZIP code associated with the location of cashing station 101 may be indicative a likelihood of fraud associated with a check cashing request. As the first few numbers of ZIP codes typically refer to jurisdictions in a particular region of the country (e.g., ‘0’ as the first digit indicating New Jersey and much of New England, ‘070’ as the first three digits indicating portions of Northern New Jersey, and ‘1’ as the first digit indicating New York and Pennsylvania). Decision system 105, as explained above with respect to FIG. 2A, may determine a ZIP code associated with cashing station 101, and check the first three digits against the score model represented by table 300A to determine a point value associated with the ZIP code.

In example table 300A, ZIP3 field 303 is divided into four groups, as illustrated in table 304. Table 304 contains four groups (Groups 1-4) including ZIP code prefixes. Table 300A awards another point value to any other ZIP codes by classifying them into a fifth group. (The ZIP code subsets in table 304 are not exhaustive and are for illustrative purposes only.) Decision system 105 can look up the ZIP Code in table 300A to determine what group the ZIP code falls into and then determine a corresponding point value.

Table 300A may further include face amount field 305, which indicates the amount listed on check 102B that check casher 102A is requesting from the transaction. Face amounts on checks may be a good indication of fraud on a check cashing request, because those who attempt to cash a fake check may attempt to receive as much money as possible from the cashing request. In example table 300A, a first range of values (between $0.00 and $80.00) is correlated with a score of 200, indicating that a check for between zero and eighty dollars is not likely to be fraudulent. In contrast, checks for more than $1000.00 receive no score for the face amount, because it is more likely that these checks are fraudulent.

Table 300A may further include positive pay file grade field 307, which indicates a grade associated with both a user and one or more MICR lines corresponding with one or more checks. As explained above with respect to table 107 in FIG. 1, a grade associated with a user may be based on the history of the user regarding past check cashing requests. Different grades indicate different levels of trust and, consequently, a different number of associated points.

Table 300A may further include a number of payroll checks field 309. The number may indicate how many checks having a particular full MICR were cashed during a time period. For example, the value from field 309 may indicate a number of checks cashed in 30 days that each contained the same ABA (or “routing”) number and/or account number. In example table 300A, a first range of values (number of checks greater than 60) is correlated with a score of 100, indicating that if 60 or more checks have been received from a particular payor during the past 30 days, then the check is not likely to be fraudulent. In contrast, a particular payor having 60 or fewer checks cashed during a 30-day period may be indicative of a fraudulent check, and thus no points are added to the score.

Table 300A may further include an amount of time since a first cashing request field 311. This time may indicate a number of days since a first payroll check was received from check casher 102A. This may be indicative of, for example, how likely check casher 102A is to be a fraudster. In example table 300A, a first range of values (number of days since first cashing request greater than 60) is correlated with a score of 50, indicating that because check casher 102A has been cashing checks for more than a short period of time, it is unlikely that the current check presented by check casher 102A (check 102B) is fraudulent.

FIG. 3B is a table 300B representing an exemplary check cashing model for use in scoring an enrollment check cashing request, consistent with disclosed embodiments. Table 300B includes variables of varying importance, and correlates values (or ranges of values) for those variables with points. Decision system 105 may use table 300B to score check cashing requests. In some embodiments, decision system 105 may consult databases, such as knowledge file 107, to determine information about check casher 102A, check 102B, bank 103, or cashing station 101. As explained above with respect to FIG. 3A, in some embodiments, the points awarded to a check cashing request having a variable with a particular value are based on the percentage of observed checks (e.g., previously deposited or cashed checks) having the particular value (“% of Population” in FIG. 3B) and how predictive of loss the particular value is (“Importance” in FIG. 3B). One of ordinary skill will understand that the particular variables and values are provided for example only, and may be substituted, omitted, or modified as appropriate.

Table 300B, like table 300A in FIG. 3A, may include a constant point value field 321. Decision system 105 may add a constant point value from field 321 when calculating a risk score for a check cashing request. The constant point value field may be calibrated such that scores generated using table 300B are correlated to risk. For example, the score may be generated on an exponential scale as explained above with respect to FIG. 1.

Table 300B may further include a maximum face amount field 323 for checks cashed during a time period by check casher 102A. Values in maximum face amount field 323 may indicate a maximum face amount for checks that check casher 102A has attempted to cash during the past three days (e.g., past three calendar days, past three business days, or past 72 hours). In example table 300B, a maximum face amount of less than or equal to $40.00, or a missing maximum face amount, yields 100 points, a maximum face amount between $40.01 and $400.00 yields 50 points, and a maximum face amount greater than $400.00 yields zero points.

Table 300B may further include a total number of payroll checks field 325 for checks cashed during a time period that contain the same full MICR. For example, decision system 105 may determine the number of payroll checks received in the past 30 days that have a MICR (e.g., equal ABA/routing number and/or account number) equal to the MICR on check 102B. In example table 300B, if more than 100 checks have had identical full MICRs during the past 30 days, table 300B yields 100 points, if greater than two and less than or equal to 100 checks have had identical full MICRs during the past 30 days, table 300B yields 10 points, and if less than or equal to two checks have had identical full MICRs during the past 30 days (or if there is no information on a number of checks with identical full MICRs), table 300B yields zero points.

Table 300B may further include a minimum face amount field 327 for checks declined during a particular time period. Values in minimum face amount field 327 may indicate, for example, the minimum face amount for check cashing requests that were declined during the past three days (e.g., past three calendar days, past three business days, or past 72 hours). In example table 300B, if there is no information on declined checks during the past three days (e.g., because no checks have been declined during the past three days), then table 300B yields 100 points; otherwise, table 300B yields zero points.

Table 300B may further include a number of checks field 329, for checks cashed by check casher 102A and approved during a particular time period. The value from field 329 may indicate, for example, a number of checks cashed by check casher 102A during the past six months. In example table 300B, greater than 21 checks yields 75 points, greater than eight and less than or equal to 21 checks yields 20 points, greater than two checks and less than or equal to eight checks yields 10 points, and less than or equal to two checks (or a missing number of checks) yields zero points.

Table 300B may further include a measurement of a number of standard deviations field 331, representing a face amount associated with check 102B deviates from the average of all checks cashed by check casher 102A during a particular time period. For example, decision system 105 may calculate the standard deviation (σ) of the face amount on checks cashed by check casher 102A during the past 24 months, the average face amount for checks cashed during the past 24 months, and the number of standard deviations that the face amount on check 102B deviates from the average. The number of standard deviations may be calculated as:

$$\frac{Face Amount - avg ( Face Amount )}{σ ( Face Amount )} .$$

In example table 300B, if a face amount on check 102B is less than or equal to 1.3000 standard deviations from the average, table 300B awards 50 points to check 102B, while a number of standard deviations greater than 1.3000 (or a missing number of standard deviations) yields zero points.

Table 300B may further include a total claim amount 333 for checks cashed by check casher 102A during a particular time period. For example, decision system 105 may determine a total amount for checks cashed during a time period encompassing the 21 months beginning three months before the date of the check cashing request. (So, for example, if the check cashing request was initiated on Apr. 1, 2013, then the total amount would be calculated based on checks cashed from January 2011-December 2012.) In example table 300B, if the total amount for that time period is larger than zero dollars, then table 300B yields zero points; however, if no checks have been cashed during that time period, then table 300B yields 75 points.

Table 300B may further include a number of visits field 335 representing visits by check casher 102A to cashing station 101 during a particular time period. For example, decision system 105 may determine the number of visits by check casher 102A to cashing station 101 during the past 24 months. In example table 300B, if check casher 102A has visited cashing station 101 at least once in the last 24 months, table 300B yields a score of 50; however, if check casher 102A has not visited cashing station 101 during the last 24 months or there is no information on check casher 102A visiting cashing station 101 during the last 24 months, then table 300B yields zero points.

Table 300B may further include a number of government checks field 337, representing government checks cashed at cashing station 101 during a particular time period. For example, decision system 105 may determine a total number of government checks cashed at cashing station 101 during the last 12 months. In example table 300B, if more than five government checks have been cashed at cashing station 101 during the past 12 months, then table 300B yields 50 points; otherwise, table 300B yields zero points.

Table 300B may further include a measurement of a number of standard deviations field 339, representing check numbers (e.g., a unique numerical identifier for each check) corresponding to checks cashed by check casher 102A during a particular time period. For example, decision system 105 may calculate the standard deviation (a) of the check numbers for checks cashed by check casher 102A during the past six months, the average check number for checks cashed during the past six months, and the number of standard deviations that the check number on check 102B deviates from the average. The number of standard deviations may be calculated as:

$$\frac{Check Number - avg ( Check Number )}{σ ( Check Number )} .$$

In example table 300B, if a check number on check 102B is greater than 0.2000 or less than or equal to 2.2000 standard deviations from the average, table 300B awards 20 points to check 102B, a number of standard deviations greater than −0.3000 and less than or equal to 0.2000, or greater than 2.2000 yields 10 points, and less than or equal to −0.3000 standard deviations (or a missing standard deviation) yields zero points.

The variables in example FIGS. 3A and 3B are not the only variables usable by decision system 105 for scoring a check cashing request. Other variables include, for example: a check number associated with check 102B (e.g. check number 102B-9), codes associated with an issuer of check 102B (e.g., a Standard Industrial Classification code indicating the line of business in which the check issuer is engaged), an age associated with check casher 102A, a local time or day of the week at cashing station 101 at the time of the check cashing request, a percentage of cashed checks at cashing station 101 that are in a particular risk category, a difference between the face amount of check 102B (e.g., amount 102B-3) and the average face amount for checks cashed at cashing station 101 during a time period, whether a zip code associated with cashing station 101 is the same as a zip code from which a majority of checks have been cashed during a time period, or the like.

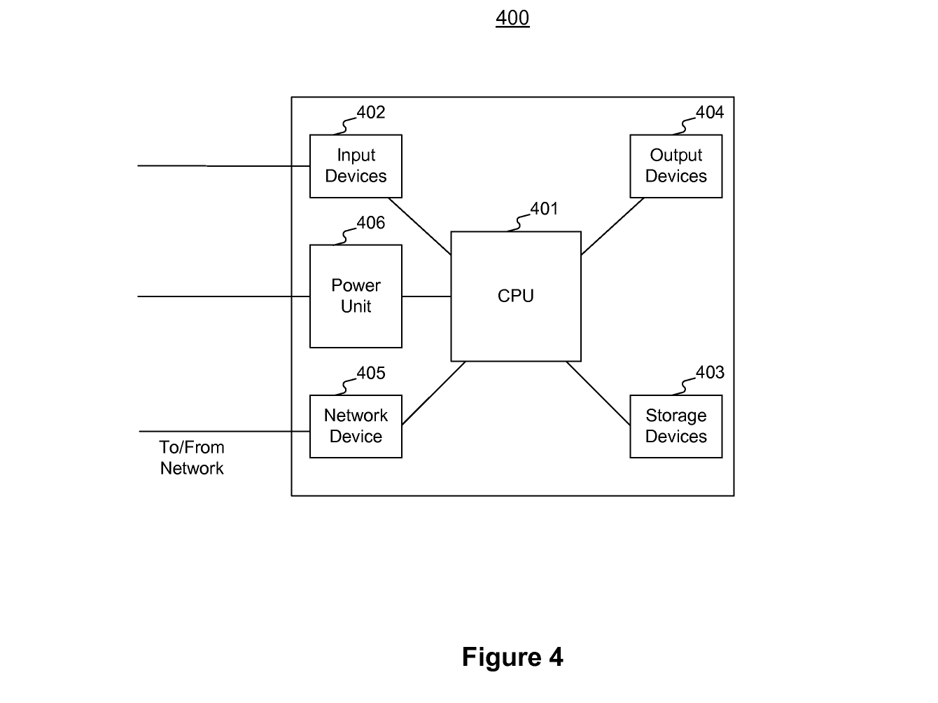

FIG. 4 is an exemplary computing device 400, consistent with disclosed embodiments. Variations of computer device 400 may be used for implementing any of cashing station 101, banks 103, decision system 105, knowledge file 107, or negative file 109.

As shown in FIG. 4, exemplary computer device 400 may include one or more central processing units (CPUs) 401 for managing and processing data and operations consistent with the disclosed embodiments. CPU 401 may be configured to process data, execute software instructions stored in memory, and transmit data between the other components of device 400. For example, CPU 401 may be implemented as a microprocessor in a mobile device, a desktop device, a server device, or any other type of device using a processor, as one of ordinary skill will understand.

In some embodiments, computer device 400 may also include one or more input devices 402, which are configured to receive input from a user, other computers, other devices, or other modules. Input devices 402 may include, but are not limited to, keyboards, mice, trackballs, trackpads, scanners, cameras, external storage or information devices, and other devices, which connect via Universal Serial Bus (USB), serial, parallel, infrared, wireless, wired, or other connections.

Computer device 400 may also include one or more storage devices 403. Storage devices 403 may comprise optical, magnetic, signal, or any other type of memory configured to store information. Storage devices 403 may store, for example, data, instructions, programs/applications, operating systems, or a combination of these.

Computer device 400 also includes one or more output devices 404 that may be configured to transmit data to users, modules, or other devices. Such modules or devices may include, but are not limited to, computer monitors, televisions, screens, interface ports, projectors, printers, plotters, and other recording/displaying devices which connect via wired or wireless connections.

Computer device 400 may also include one or more network devices 405. Network device 405 may be configured to allow computer device 400 to connect to and exchange information with networks (e.g., network 111), such as the Internet, a local area network, a wide area network, a cellular network, a wireless network, or any other type of network. Network device 405 may be implemented as a wired network adapter, a wireless network adapter, an infrared network adapter, a cellular or satellite network adapter, or any other type of network adapter.

Computer device 400 may also include one or more power units 406, which may enable computer device 400 and its components to receive power and operate.

While FIG. 4 illustrates the components in FIG. 4 as connected to CPU 401, other connections and configurations are possible, such as a “bus” or other connective links. Additionally, while the devices in FIG. 4 are represented in a singular form, one of ordinary skill will understand that, in some embodiments, each of the devices in FIG. 4 may be omitted, duplicated, or substituted.

Various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner and/or replaced or supplemented by other components. Advantageous results may still be achieved if values or data were different than explicitly disclosed. Other implementations are also within the scope of the present disclosure.

It is to be understood that both the foregoing general description and the following detailed description are exemplary and explanatory only and are not restrictive of the disclosed embodiments, as claimed. Note also that, as used herein, the indefinite articles “a” and “an” mean “one or more” in open-ended claims containing the transitional words “comprising,” “including,” and/or “having.”

The accompanying drawings, which are incorporated in and constitute a part of this specification, illustrate one or more embodiments and together with the description, serve to explain certain aspects of the disclosed embodiments.

What is claimed is:

1. A method for processing check cashing requests, comprising:
receiving from a cashing station having associated cashing station data, using at least one processor, a transaction request including check data and identity data associated with a user;
determining whether the transaction request represents a first transaction request from the user at the cashing station, comprising:
if it is determined that the transaction request represents a first transaction request, performing an enrollment validation process and an identification authentication process; and
if it is determined that the transaction request does not represent a first transaction request:
performing a repeat validation process; and
performing a check casher identification process, by retrieving and matching data associated with the user from a database; and
if either of the enrollment validation process or repeat validation process passes, determining whether there is a match between data in a negative file and at least one of the check data or the identity data;
if there is no match in the negative file, determining whether there is a match between data in a knowledge file and at least one of the check data or the identity data;
calculating, using the at least one processor, a score for the check cashing transaction based on at least one of the cashing station data, the check data, the identity data, or checks of previously received transaction requests;
determining whether the score is above a threshold; and
based on the determination, generating, using the at least one processor, an indication that the transaction should be approved.

2. The method of claim 1, wherein determining there is no match in the negative file comprises determining the identity data is not present in the negative file.

3. The method of claim 2, wherein determining whether either of check data or the identity data matches data in a knowledge file comprises:
determining whether a MICR line printed on the check is in the negative file; and
if the MICR line is in the negative file, determining whether the MICR line is on an override list in the knowledge file; and
if the MICR line is not on the override list, declining the transaction.

4. The method of claim 1, wherein determining whether either of the check data or the identity data matches data in a knowledge file comprises:
determining whether a MICR line printed on the check and the identity data matches data in the knowledge file; and
if the MICR line printed on the check and the identity data match data in the knowledge file, approving the transaction.

5. The method of claim 1, wherein calculating the score further comprises:
determining whether at least part of at least one of the cashing station data, the check data, or the identity data appears in a table listing possible values for at least one of the cashing station data, the check data, or the identity data;
based on the determination, determining a number of points associated with the data in the table and summing the points associated with the data in the table to calculate the score.

6. The method of claim 5, wherein if the transaction request represents a first transaction request, then determining the score based on at least one of:
a location of the cashing station, a face amount of the check, a grade associated with the user, a number of payroll checks cashed with a MICR line equal to a MICR line printed on the check, or an amount of time since a first payroll check was cashed by the user.

7. The method of claim 6, wherein determining the score based on a location of the cashing station further comprises:
determining a ZIP code associated with the cashing station;
determining a subset of the ZIP code;
determining a group of ZIP code subsets in which the subset of the ZIP code appears; and
determining the score based at least in part on a number of points associated with the group of ZIP code subsets.

8. The method of claim 5, wherein if the transaction request does not represent a first transaction request, then determining the score based on at least one of:
a value associated with a highest-value check cashed by the user, a number of checks with a MICR line equal to a MICR line printed on the check, a number of approved checks cashed by the user, a number of standard deviations that the face amount of the check is from an average face amount of other checks cashed by the user, a total value of all checks cashed by the user, a number of visits by the user to the cashing station, a number of government checks cashed at the cashing station, or a number of standard deviations that a check number associated with the check is from an average check number of other checks cashed by the user.

9. A system for generating a score for a check cashing transaction, comprising:
a storage device, containing instructions; and
at least one processor configured to execute the instructions to:
receive from a cashing station, having associated cashing station data, a transaction request including check data and identity data associated with a user;
determine whether the transaction request represents a first transaction request from the user at the cashing station, comprising:
if it is determined that the transaction request represents a first transaction request, the at least one processor performs an enrollment validation process and an identification authentication process, and
if it is determined that the transaction request does not represent a first transaction request, the at least one processor:
performs a repeat validation process; and
performs a check casher identification process, by retrieving and matching data associated with the user from a database; and
if either of the enrollment validation process or repeat validation process passes, determine whether there is a match between data in a negative file and at least one of the check data or the identity data;
if there is no match in the negative file, determine whether there is a match between data in a knowledge file and at least one of the check data or the identity data;
calculate a score for the check cashing transaction based on at least one of the cashing station data, the check data, the identity data, or checks of previously received transaction requests;
determine whether the score is above a threshold; and
based on the determination, generate an indication that the transaction should be approved.

10. The system of claim 9, wherein determining there is no match in the negative file comprises determining that the identity data is not present in the negative file.

11. The system of claim 10, wherein determining whether either of check data or the identity data matches data in a knowledge file comprises:
determining whether a MICR line printed on the check is present in the negative file; and
if the MICR line is present in the negative file, determining whether the MICR line is on an override list in the knowledge file; and
if the MICR line is not on the override list, declining the transaction.

12. The system of claim 9, wherein determining whether either of the check data or the identity data matches data in a knowledge file comprises:
determining whether a MICR line printed on the check and the identity data matches data in the knowledge file; and
if the MICR line printed on the check and the identity data match data in the knowledge file, approving the transaction.

13. The system of claim 9, wherein calculating the score further comprises:
determining whether at least part of at least one of the cashing station data, the check data, or the identity data appears in a table listing possible values for at least one of the cashing station data, the check data, or the identity data;
based on the determination, determining a number of points associated with the data in the table and summing the points associated with the data in the table to calculate the score.

14. The system of claim 13, wherein if the transaction request represents a first transaction request, then determining the score based on at least one of:
a location of the cashing station, a face amount of the check, a grade associated with the user, a number of payroll checks cashed with a MICR line equal to a MICR line printed on the check, or an amount of time since a first payroll check was cashed by the user.

15. The system of claim 14, wherein determining the score based on a location of the cashing station further comprises steps of:
determining a ZIP code associated with the cashing station;
determining a subset of the ZIP code;
determining a group of ZIP code subsets in which the subset of the ZIP code appears; and
determining the score based at least in part on a number of points associated with the group of ZIP code subsets.

16. The system of claim 13, wherein if the transaction request does not represent a first transaction request, then determining the score based on at least one of:
a value associated with a highest-value check cashed by the user, a number of checks with a MICR line equal to a MICR line printed on the check, a number of approved checks cashed by the user, a number of standard deviations that the face amount of the check is from an average face amount of other checks cashed by the user, a total value of all checks cashed by the user, a number of visits by the user to the cashing station, a number of government checks cashed at the cashing station, or a number of standard deviations that a check number associated with the check is from an average check number of other checks cashed by the user.

17. A non-transitory computer-readable storage medium comprising instructions that, when executed by at least one processor, causes the at least one processor to:
receive from a cashing station, having associated cashing station data, a transaction request including check data and identity data associated with a user;
determine whether the transaction request represents a first transaction request from the user at the cashing station, comprising:
if it is determined that the transaction request represents a first transaction request, perform an enrollment validation process and an identification authentication process, and
if it is determined that the transaction request does not represent a first transaction request:
perform a repeat validation process, and
perform a check casher identification process, by retrieving and matching data associated with the user from a database; and
if either of the enrollment validation process or repeat validation process passes, determine whether there is a match between data in a negative file and at least one of the check data or the identity data;
if there is no match in the negative file, determine whether there is a match between data in a knowledge file and at least one of the check data or the identity data;
calculate a score for the check cashing transaction based on at least one of the cashing station data, the check data, the identity data, or checks of previously received transaction requests;
determine whether the score is above a threshold; and
based on the determination, generate an indicating that the transaction should be approved.

18. The medium of claim 17, wherein determining there is no match in the negative file comprises determining that the identity data is not present in the negative file.

19. The medium of claim 18, wherein determining whether either of check data or the identity data matches data in a knowledge file comprises steps of:
determining whether a MICR line printed on the check is present in the negative file; and
if the MICR line is present in the negative file, determining whether the MICR line is on an override list in the knowledge file; and
if the MICR line is not on the override list, declining the transaction.

20. The medium of claim 17, wherein determining whether either of the check data or the identity data matches data in a knowledge file comprises steps of:
determining whether a MICR line printed on the check and the identity data matches data in the knowledge file; and
if the MICR line printed on the check and the identity data match data in the knowledge file, approving the transaction.

21. The medium of claim 17, wherein calculating the score further comprises steps of:
determining whether at least part of at least one of the cashing station data, the check data, or the identity data appears in a table listing possible values for at least one of the cashing station data, the check data, or the identity data;
based on the determination, determining a number of points associated with the data in the table and summing the points associated with the data in the table to calculate the score.

22. The medium of claim 21, wherein if the transaction request represents a first transaction request, then determining the score based on at least one of:
a location of the cashing station, a face amount of the check, a grade associated with the user, a number of payroll checks cashed with a MICR line equal to a MICR line printed on the check, or an amount of time since a first payroll check was cashed by the user.

23. The medium of claim 22, wherein determining the score based on a location of the cashing station further comprises steps of:
determining a ZIP code associated with the cashing station;
determining a subset of the ZIP code;
determining a group of ZIP code subsets in which the subset of the ZIP code appears; and
determining the score based at least in part on a number of points associated with the group of ZIP code subsets.

24. The medium of claim 21, wherein if the transaction request does not represent a first transaction request, then determining the score based on at least one of:
a value associated with a highest-value check cashed by the user, a number of checks with a MICR line equal to a MICR line printed on the check, a number of approved checks cashed by the user, a number of standard deviations that the face amount of the check is from an average face amount of other checks cashed by the user, a total value of all checks cashed by the user, a number of visits by the user to the cashing station, a number of government checks cashed at the cashing station, or a number of standard deviations that a check number associated with the check is from an average check number of other checks cashed by the user.
